(19) United States
(12) Patent Application Publication
(10) Pub. No.: US 2014/0208877 A1
(43) Pub. Date: Jul. 31, 2014

(54) Probe Body- Retaining Arrangement

(71) Applicant: Jenoptik Industrial Metrology Germany GmbH, Villingen-Schwenningen (DE)

(72) Inventor: Wolfgang Speck, Villingen-Schwenningen (DE)

(73) Assignee: Jenoptik Industrial Metrology Germany GmbH, Villingen-Schwenningen (DE)

(21) Appl. No.: 14/168,244

(22) Filed: Jan. 30, 2014

(30) Foreign Application Priority Data
Jan. 30, 2013 (DE) 10 2013 001 561.8

(51) Int. Cl. G01D 11/30

(52) U.S. Cl. CPC G01D 11/30
USPC 73/866.5

(57) ABSTRACT

A measuring head 2 for a measuring device, in particular a geometrical and dimensional measuring device, having a base body 4, which on the one hand can be connected to or is connected to the measuring device, and which on the other hand carries a probe body. An overload protection mean is provided, which in order to protect the measuring head or as the case may be the measuring device, from damage, is tripped in the event of an overload acting on the probe body. The overload protection means is inventively configured as an irreversible overload protection means 12, 14, 16, 18.

### CROSS-REFERENCE TO RELATED APPLICATIONS

This application claims priority to German Patent Application serial number 10 2013 001 561.8 filed Jan. 30, 2013, entitled “Tastkörper-Halteanordnung,” which is incorporated by reference herein. in its entirety.

The invention applies to a measuring head of the type named in the preamble to claim 1.

A measuring head is known from DE 30 22 296 A1 that has a base body which, on the one hand can be connected to or is connected to the measuring device, and which on the other hand carries a probe body. The known measuring body also has an overload protection means which is tripped to protect the measuring head and/or the measuring device against damage in the event of an overload acting on the probe body. In the case of the measuring head known from this reference, the overload protection means is comprised of a magnetic coupling, the measuring head having a permanent magnet by means of which the probe body is held in the measuring position on the measuring head. If a force acting on the probe body or on a retaining arrangement that holds the probe body on the measuring head exceeds a maximum value, and an overload therefore arises, the retention force of the permanent magnet is overcome, so that the probe body, or as the case may be its retaining arrangement, for example a sensing arm, detaches from the measuring head. The magnetic force of the permanent magnet is gauged such that the forces which arise during normal measuring operation, and which act on the probe body or as the case may be the retaining arrangement, do not lead to a tripping of the overload protection means. If an overload occurs, the current measuring operation is interrupted, however at the same time the measuring head and the measuring device are protected against damage so that time-consuming and costly repairs are not required. The only thing required to put the measuring device back into operation is to reconnect the probe-body retaining arrangement to the measuring device by means of its permanent magnet.

Similar overload protection means which work with permanent magnets are known from U.S. Pat. No. 4,574,625, EP 1 589 317 B1, EP 0 406 781 B1, DE 33 20 127, EP 1 589 317 A1, DE 10 2007 018 444 B3, WO 02/27270 A1, DE 10 2005 036 928 B3, DE 196 17 023 C1, DE 196 17 023, U.S. Pat. No. 5,028,901, EP 0 750 017 A2, DE 44 37 033 C2 and WO 03/033 407 as well as the post-published German patent application no. 10 2012 007 183.3.

The object of the invention is to provide a measuring head which is also suitable for use in in-process measuring applications. This object is achieved by means of the invention presented in Claim 1.

The invention represents a departure from the idea predominant in the state of the art of designing the overload protection means, which is tripped in order to protect the measuring head, or as the case may be the measuring device from damage when an overload acting on the probe-body retaining arrangement arises, as a reversible overload protection means. Instead, the invention is based on the idea of designing the overload protection area irreversible overload protection. For example, and in particular, the base body can have, on at least one protection element, at least one disconnection point, at which at least one protection element breaks when an overload arises. In this manner, overload protection of the measuring head, or as the case may be the measuring device, is still ensured, however at the same time, there is no need for a magnetic connection of the retaining arrangement, for example a sensing arm, to the measuring head. In this way, a considerable advantage is achieved compared to a magnetic connection to the measuring head, particularly when there is a rough measuring environment, for example with an in-process measuring application. With the type of magnetic coupling previously referred to, there is the risk that shavings or other metallic material can accumulate at the disconnection point between the probe-body retaining arrangement—also referred to simply as the retaining arrangement—and the measuring head, which results in the connection to the area head no longer taking place with the required precision, which can result in measurement errors. Furthermore, with the inventive measuring head, there is no risk of breakdowns due to the accumulation of shavings or similar material in the region of the connection. In one embodiment of the kind described above, the disconnection point can, in particular, be selected such that the broken protection element, or as the case may be the broken protection elements, can be replaced easily and without major expense.

In contrast to a magnetic connection, with the use of protection elements comprised in particular of brittle material, there is the additional advantage that the tripping of the overload protection takes place at a clearly defined force.

After a tripping of the irreversible overload protection in the sense of the invention, the measuring device cannot be brought back to an operating state without tools or auxiliary means, for example by replacing broken protection elements. On the other hand, reversible overload protection is understood as overload protection, after whose triggering the measuring device can be restored to its operating state without tools, or as the case may be auxiliary means, for example by reattaching a magnetically coupled probe-body retaining arrangement to the measuring device.

An advantageous further development of the invention provides for the base body to have at least one disconnection point on at least one protection element, at which point the protection element breaks when an overload occurs. If an overload occurs at the probe-body retention arrangement, or as the case may be the probe body, the protection element breaks in order to prevent damage to the measuring head, or as the case may be the measuring device. The measuring head is subsequently restored to the operating state by replacing the protection element.

In order to ensure simple and rapid replacement of the protection element, or as the case may be the protection elements, an advantageous further development of the previously mentioned embodiment provides for the base body to have a protection unit which has a first component which is connected to or can be connected to the probe body and second component that is connected to or can be connected to the measuring head, wherein the first component is connected to the second component via the protection element or the protection elements. In this embodiment, the first component of the protection unit can be connected to the probe body, in particular in a detachable manner, while the second component can be detachably connected to the measuring head, for example in each case by means of a screwed fastening. When the overload protection is tripped, a break occurs between the first and the second component, whereby due to the breaking of the protection element or the protection elements, the first component in particular can be disconnected from the second component. Here, in order to restore the measuring head to the operating state, the first and the second component can be detached from the probe body, or as the case may be the measuring head, by unscrewing the screwed fastening. In order to restore the measuring head and thus the measuring device to the operating state, a new protection unit is used, which is in turn connected to the measuring head. In this way, the protection unit forms a disposable part, which is disposed of after the triggering of the overload protection and replaced by a new protection unit.

An available inventive protection unit of a measuring head having a base body is shown, for example, as a spare part in claim 4. The base body has a disconnection point on at least one protection element, at which disconnection point the protection element breaks when an overload occurs, wherein the protection unit has a first component that is connected to or can be connected to the probe body, and a second component that is connected to or can be connected to probe body, wherein the first component is connected to the second component by means of the protection element or the protection elements. This produces the advantages described above.

An extraordinarily advantageous further development of the inventive measuring head, or as the case may be the inventive protection unit, provides for at least one protection element to be comprised of a brittle material, in particular a ceramic. With this embodiment, the protection element breaks when a clearly defined overload arises, however it is stable prior to that, so that unwanted displacements or elastic deformations that could result in a distortion of the measurement results are avoided.

The shape, size, and number of the protection element, or as the case may be the protection elements, can be selected within wide limits. In this respect, an advantageous further development of the inventive measuring head, or as the case may be the inventive protection element, provides for the at least one protection element to be designed as rod-shaped or approximately rod-shaped.

Another advantageous further development of the invention provides for the longitudinal axis of at least one protection element to run transversely to the longitudinal axis of the base body of the probe-body retaining arrangement that points from the measuring device to the probe body. With this embodiment, there are particularly good trip characteristics with respect to the tripping of the overload protection.

Another advantageous further development of the invention provides for the existence of at least two protection elements of the same type, which are arranged parallel to each other or approximately parallel to each other.

The protection element connects, or the as the case may be the protection elements advantageously connects connect the first component to the second component in a statically determinate manner, as provided for in a further development of the invention.

The basic idea of the invention, namely that of providing an irreversible overload protection means, can also be realized in a manner other than that of providing a disconnection point at which a protection element breaks. Another advantageous further development of the invention provides, for example, for the base body to have at least one protection element at least one junction, said protection element being comprised of a shape memory material, in particular a shape memory alloy, which is deformed when an overload arises. With this embodiment, the irreversibility of the overload protection is seen in it being impossible to put the measuring device, after a tripping of the overload protection, back into the operating state without the use of tools, or as the case may be auxiliary means, for example by means of the deformed protection element being heated.

In this respect, a further development of the previously mentioned embodiment provides for restoration of the shape memory material to its original shape under the effect of heat.

In order to make the replacement of the protection unit, after the tripping of the overload protection, particularly simple, time-saving, and thus cost-efficient, an advantageous further development provides for the protection unit to be detachably connectable or detachably connected, on the one hand to the probe body or with a part of the base body carrying the probe body, and on the other hand detachably connectable or connected to the measuring device or a part of the base body that can be connected to the measuring device.

An inventive measuring device that has an inventive probe-body retaining arrangement according to one of the Claims 1 to 3 or 5 to 12, and/or an inventive protection unit according to one of the Claims 4 to 9, is specified in Claim 13.

The invention will be explained below by means of the attached drawing, in which an embodiment of an inventive probe-body retaining arrangement is presented in highly schematized form. Here all of the features described, depicted in the drawing, or claimed in the patent claims make up the matter of the invention, taken together or in any suitable combination, independently of the way they are summarized in the patent claims and their back-reference, as well as independently of their description, or as the case may be, depiction in the drawing.

Shown are:

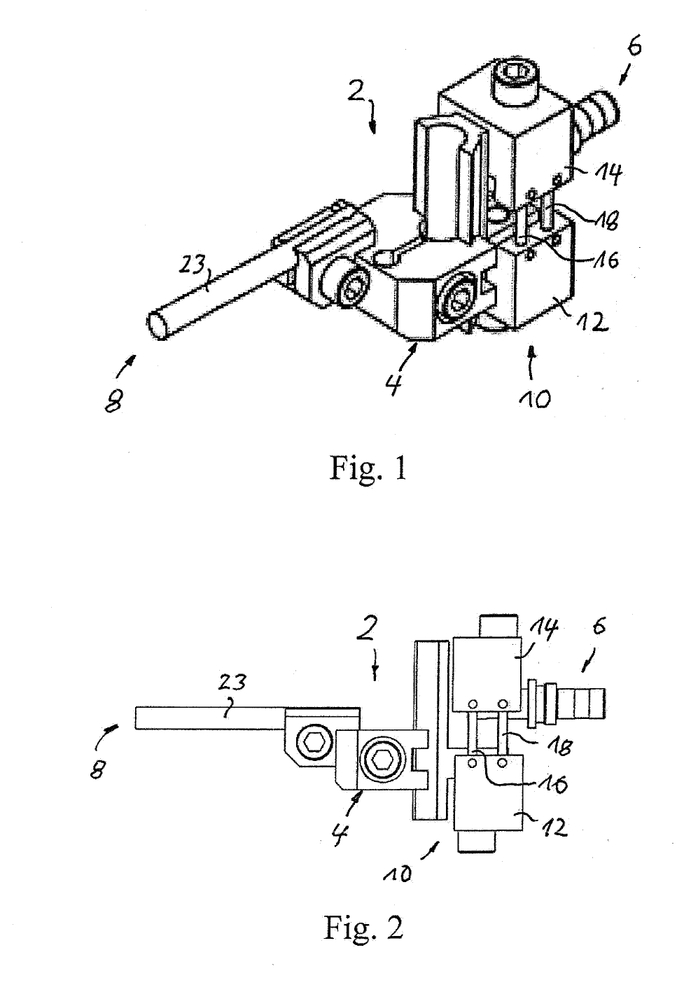

FIG. 1 in a schematic perspective view, an embodiment of an inventive measuring head,

FIG. 2 a first side view of the measuring head according to FIG. 1,

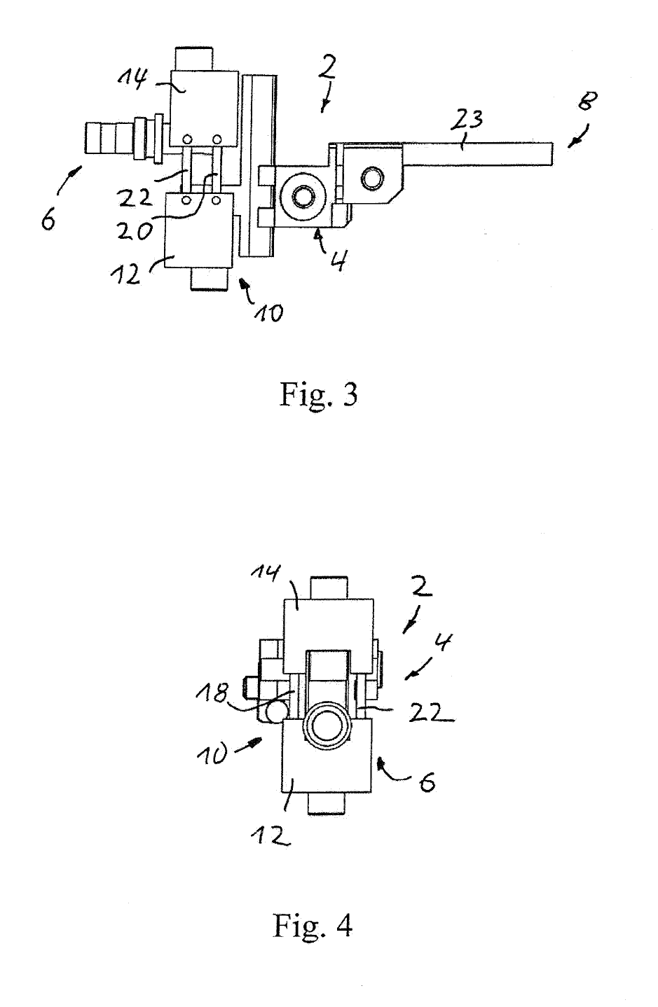

FIG. 3 an additional side view of the measuring head according to FIG. 1,

FIG. 4 a rear view of the measuring head according to FIG. 1.

In FIG. 1, an embodiment of an inventive measuring head 2 for a measuring device is shown, in particular a geometric or dimensional measuring device which has a base body 4 which in the operating state of the measuring device is, on the one hand connected at its proximal end 6 to the measuring device, and on the other hand carries a probe body at its distal end 8. The measuring head 2 has an overload protection means, which, for the protection of the measuring head 2, or as the case may be the measuring device, is tripped in the event of an overload acting on the probe body, or as the case may be on a retaining arrangement of the probe body. According to the invention, the overload protection is configured as an irreversible overload protection means.

In the embodiment shown, the base body 4 has a protection unit 10. In the operating state of the measuring device, the protection unit 10 has a first component 12 that is connected to the distal end 8 of the measuring head 2 and thus to the probe body, and a second component 14 which, in the operating state of the measuring device, is connected to the same. In this embodiment, the first component 12 and the second component 14 are designed as blocks and are each connected by means of a screwed fastening to the proximal end of the measuring head 2, or as the case may be the measuring device.

The protection device also features protection elements by means of which the first component 12 is connected to the second component 14. In the embodiment shown, four protection elements are provided, which are designed as thin rods and are comprised in this embodiment of a brittle material, namely a ceramic.

In FIG. 1, only two protection elements can be seen and are provided with the reference signs 18, 18. It is not apparent from FIG. 1, and will therefore be explained here, that in addition to the protection elements 16, 18, two additional protection elements 20, 22 are provided. All protection elements are designed as being of the same type, that is, they are comprised of a brittle material and are designed as rod-shaped. It is not apparent from FIG. 1 and will therefore be explained here that the protection elements 16, 18 and the additional protection elements 20, 22, which are not seen, proceed from the corners of a quadrangle.

FIG. 2 shows a side view of the measuring head 2, where the protection elements 16, 18 are discernible.

FIG. 3 shows a side view of the measuring head 2 from the opposite side, where the additional protection elements 20, 22 are discernible.

FIG. 4 shows a view of the proximal end 6 of the measuring head 2.

The inventive measuring head 2 functions as follows:

When the measuring device is in operation, a surface is scanned by means of a probe body arranged at the distal end 8 of the base body 4. During this process, if an overload acts on the probe body and/or the probe-body retaining arrangement (scanning arm 23), a brittle fracture occurs in the protection elements 16, 18 and in the additional protection elements 20, 22; such that the protection elements break at their provided disconnection points. In this way, the first component 12 detaches from the second component 14, so that forces acting on the measuring head 2 are not transmitted to the measuring device. In this way, the measuring device and the measuring bead 2 are protected against damage.

After the overload protection means is tripped, the component 12 is detached from the measuring head 2 and the second component 14 from the measuring device by the release of the screwed connections. The protection unit 10, which in this embodiment forms the irreversible overload protection means, is subsequently disposed of and replaced by a new protection unit, whose first component is in turn connected to the measuring head 2 and whose second component is connected to the measuring device. After that, the measuring operation can be resumed.

The invention therefore provides an irreversible overload protection means for measuring devices which, on the one hand, ensures protection against damage to the measuring device, however at the same time makes it possible to quickly put the measuring device back into operation after the tripping of the overload protection means.

1. A measuring head for a measuring device, comprising:
a base body, which on the one hand can be or is connected to the measuring device, and on the other hand carries a probe body; and
an overload protection means which is tripped in order to protect the measuring head and/or the measuring device against damage in the event of an overload acting on the probe head,
wherein the overload protection means is configured as an irreversible overload protection means.

2. The measuring head according to claim 1, wherein the base body has on at least one protection element at least one disconnection point at which the protection element breaks in the event of an overload.

3. The measuring head according to claim 2, wherein the base body has a protection unit which has a first component which is connected or can be connected to the probe body, and a second component which is connected to or can be connected to the measuring head, wherein the first component is connected via the protection element or the protection elements to the second component.

4. A protection unit of a measuring head for a measuring device, said measuring head having a base body, wherein the base body, on at least one protection element, has a disconnection point at which the protection element breaks in the event of an overload, wherein the protection unit has a first component which is connected to or can be connected to the probe body, and a second component which can be connected to the measuring device, or which is connected to or can be connected to a part of the base body which can be connected to the measuring device, wherein the first component is connected via the protection element or the protection elements to the second component.

5. The measuring head according to claim 2, wherein at least one protection element is comprised at least in part of a brittle material.

6. The measuring head according to claim 2, wherein at least one protection element is designed as rod-shaped.

7. The measuring head according to claim 2, wherein the longitudinal axis of at least one protection element runs transversely to the longitudinal axis of the base body of the probe-body retaining arrangement, the longitudinal axis of said base body pointing from the measuring device to the probe body.

8. The measuring head according to claim 2, wherein at least two protection elements of the same type are arranged parallel or approximately parallel to each other are provided.

9. The measuring head according to claim 2, wherein the protection element or the protection elements connect, or as the case may be can connect the first component in a statically determinate manner to the second component.

10. The measuring head according to claim 2, wherein the base body has at least one protection element at least one junction, said protection element being comprised of a shape memory material, said protection element being deformed in the event of an overload.

11. The protection element according to claim 10, wherein the shape memory material can be returned to its original shape when subjected to heat.

12. A protection unit according to claim 4, wherein the protection unit is, on the one hand, releasably connected to the probe body or a part of the base body carrying the probe body, and on the other hand releasably connectable or connected to the measuring head.

13. A measuring device, comprising a measuring head according to claim 1.

14. A measuring head according to claim 10, wherein the shape memory material is a shape memory metal.

15. A measuring device according to claim 13, wherein the measuring device is a geometrical or dimensional measuring device.

16. The protection element according to claim 1, wherein the shape memory material can be returned to its original shape when subjected to heat.

17. A measuring device, comprising a protection unit according to claim 4.

18. The measuring head according to claim 2, wherein at least one protection element is comprised at least in part of a ceramic.

19. The protection unit according to claim 4, wherein at least one protection element is designed as rod-shaped.

20. The protection unit according to claim 4, wherein the longitudinal axis of at east one protection element runs transversely to the longitudinal axis of the base body of the probe-body retaining arrangement, the longitudinal axis of said base body pointing from the measuring device to the probe body.

21. The protection unit according to claim 4, wherein at least two protection elements of the same type are arranged parallel or approximately parallel to each other are provided.

22. The protection unit according to claim 4, wherein the protection element or the protection elements connect, or as the case may be can connect the first component in a statically determinate manner to the second component.

23. The protection unit according to claim 4, wherein the base body has at least one protection element at least one junction, said protection element being comprised of a shape memory material, said protection element being deformed in the event of an overload.
